(19) United States
(12) Patent Application Publication
(10) Pub. No.: US 2023/0003464 A1
(43) Pub. Date: Jan. 5, 2023

(54) HEAT EXCHANGER AND MANUFACTURING METHOD THEREOF

(71) Applicant: Korea Atomic Energy Research Institute, Daejeon (CN)

(72) Inventors: Hyunjun CHO, Daejeon (KR); June Woo KEE, Daejeon (KR); Seok KIM, Daejeon (KR); Young In KIM, Daejeon (KR); Joo Hyung MOON, Daejeon (KR); Yunbum PARK, Daejeon (KR); Soo Jai SHIN, Daejeon (KR); Seungyeob RYU, Daejeon (KR); Gilho LEE, Daejeon (KR); Minkyu LEE, Daejeon (KR); Cheong Bong CHANG, Daejeon (KR); Hun Sik HAN, Daejeon (KR); Sung Deok HONG, Daejeon (KR)

(21) Appl. No.: 17/857,585

(22) Filed: Jul. 5, 2022

(30) Foreign Application Priority Data
Jul. 2, 2021 (KR) 10-2021-0087300

(51) Int. Cl. F28F 3/08

(52) U.S. Cl. CPC F28F 3/08; F28F 2275/061

(57) ABSTRACT

A heat exchanger includes a first flow path member including a first plate having a first flow path portion providing a plurality of flow paths through which a first fluid flows, and a first bonding plate diffusion-bonded to the first plate to cover the first flow path portion; and a second flow path member including a second plate having a second flow path portion providing a plurality of flow paths through which a second fluid for exchanging heat with the first fluid flows. The first flow path member and the second flow path member are diffusion-bonded to each other.

### CROSS-REFERENCE TO REPLATED APPLICATIONS

The present application is based upon and claims the benefit of priority to Korean Patent Application No. 10-2021-0087300 filed on Jul. 2, 2021, in the Korean Intellectual Property Office, which is incorporated herein by reference in its entirety.

### TECHNICAL FIELD

The present disclosure relates to a printed circuit heat exchanger and a method of manufacturing a printed circuit heat exchanger. The present disclosure relates to the development of innovative SMART system technologies of the SMART innovative technology development project (R&D) with support from the National Research Foundation of Korea, which was funded by the Ministry of Science and ICT. The Project Serial Number of the national R&D project supporting the present disclosure is 1711129153, the Project number is 2020M2D7A1079178, the contribution rate is 1/1, the project performing organization is Korea Atomic Energy Research Institute (KAERI), and the research was performed from Jan. 1, 2021 to Dec. 31, 2021.

### BACKGROUND

In general, a printed circuit heat exchanger may be supplied with a first fluid of relatively high temperature and a second fluid of a relatively low temperature and perform heat exchange between the first fluid and the second fluid. The printed circuit heat exchanger may be manufactured by processing a mini-channel structure in a metal plate through chemical etching, then stacking plates, and performing diffusion bonding. Printed circuit heat exchangers are being used in various industries due to high heat exchange density in the mini-channel structure. Mini-channels formed in a plate may have a semicircular or rectangular cross-section with some vertices rounded.

Meanwhile, as a width of a mini-channel formed in a plate increases, a surface area between the first fluid and the second fluid may increase, thereby increasing heat transfer efficiency of a printed circuit heat exchanger. In addition, as the width of the mini-channel formed in the plate increases, a flow velocity of a fluid is reduced, thereby reducing a pressure loss.

However, there is a problem in that when some plates with mini-channels each having a large width are diffusion-bonded, pressure is not applied to some positions in the plates, so the plates may not be bonded sufficiently.

### RELATED DOCUMENT

(Patent Document 1) Korean Patent No. 10-1624561 (Registered on May 20, 2016)

### SUMMARY

In view of the above, the present disclosure provides a printed circuit heat exchanger and a method of manufacturing a printed circuit heat exchanger in which a flow path through which a fluid flows can be formed to have a large width.

The present disclosure also provides a printed circuit heat exchanger and a method of manufacturing a printed circuit heat exchanger in which diffusion bonding is possible even when a flow path of a large width is formed.

In accordance with a first aspect of the present disclosure, there is provided a heat exchanger including: a first flow path member including a first plate having a first flow path portion providing a plurality of flow paths through which a first fluid flows, and a first bonding plate diffusion-bonded to the first plate to cover the first flow path portion; and a second flow path member including a second plate having a second flow path portion providing a plurality of flow paths through which a second fluid for exchanging heat with the first fluid flows, wherein the first flow path member and the second flow path member are diffusion-bonded to each other.

In accordance with a second aspect of the present disclosure, there is provided a method of manufacturing a heat exchanger, including: a flow path portion processing step in which a flow path portion through which a fluid flows is formed in a plurality of plates; a flow path member forming step in which at least one of the plurality of plates and a bonding plate are diffusion-bonded to form a plurality of flow path members; and a heat exchanger forming step in which the plurality of flow path members are diffusion-bonded.

According to embodiments of the present disclosure, since a connection flow path having a large fluid flow area can be formed on the plate, it is possible to increase heat transfer efficiency and reduce a pressure loss. In addition, it is possible to achieve uniform flow distribution in a main heat transfer area by disposing the connecting flow path in a portion where flow distribution of a plate is made.

In addition, even if the connecting flow path is formed in the plate, since the plate and a bonding plate can be primarily diffusion-bonded to form a plurality of flow path members and the plurality of flow path members can be secondarily diffusion-bonded, it is possible to secure a yield in a diffusion bonding process.

### BRIEF DESCRIPTION OF THE DRAWINGS

FIG. 1 is a perspective view of a printed circuit heat exchanger according to a first embodiment of the present disclosure.

FIG. 2 is an exploded perspective view in which a part of the printed circuit heat exchanger of FIG. 1 is disassembled.

FIG. 3 is a cross-sectional view of the printed circuit heat exchanger of FIG. 1 taken along line III-III.

FIG. 4 is a cross-sectional view taken along line IV-IV of the printed circuit heat exchanger of FIG. 1.

FIGS. 5 and 6 are views showing a first flow path portion of the printed circuit heat exchanger of FIG. 1.

FIGS. 7 and 8 are views showing a second flow path portion of the printed circuit heat exchanger of FIG. 1.

FIG. 9 is a flowchart of a method of manufacturing a printed circuit heat exchanger according to the first embodiment of the present disclosure.

FIG. 10 is a perspective view of a printed circuit heat exchanger according to a second embodiment of the present disclosure.

FIG. 11 is an exploded perspective view in which a part of the printed circuit heat exchanger of FIG. 10 is disassembled.

FIG. 12 is a cross-sectional view taken along line XII-XII of the printed circuit heat exchanger of FIG. 10.

### DETAILED DESCRIPTION

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being ‘connected’ to, ‘supported’ by, ‘transferred’ to, or ‘contacted’ with another element, it should be understood that the element may be directly connected to, supported by, transferred to, or contacted with another element, but that other elements may exist in the middle.

The terms used in the present disclosure are only used for describing specific embodiments, and are not intended to limit the present disclosure. Singular expressions include plural expressions unless the context clearly indicates otherwise.

Further, in the present disclosure, it is to be noted that expressions, such as the upper side and the lower side, are described based on the illustration of drawings, but may be modified if directions of corresponding objects are changed. For the same reasons, some components are exaggerated, omitted, or schematically illustrated in the accompanying drawings, and the size of each component does not fully reflect the actual size.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

Hereinafter, a printed circuit heat exchanger 1 according to a first embodiment of the present disclosure will be described with reference to the drawings.

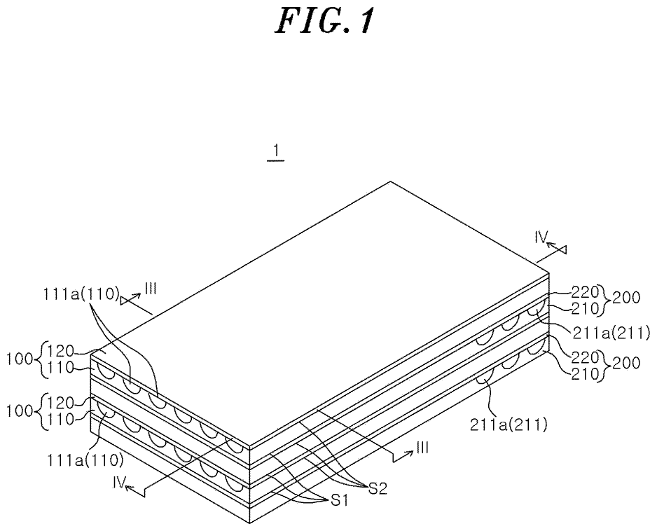

Referring to FIG. 1, a printed circuit heat exchanger 1 is a device through which a high-temperature fluid and a low-temperature fluid can flow to exchange heat with each other. In other words, the high-temperature fluid and the low-temperature fluid may be introduced into the printed circuit heat exchanger 1 to exchange heat with each other. Hereinafter, the high-temperature fluid flowing into the printed circuit heat exchanger 1 is referred to as a first fluid, and the low-temperature fluid flowing into the printed circuit heat exchanger 1 is referred to as a second fluid. In addition, the first fluid may be a reactor coolant of relatively high temperature, and the second fluid may be feedwater of relatively low temperature. The first fluid may be discharged from the printed circuit heat exchanger 1 with a lower temperature by heat exchange with the second fluid. The second fluid may be discharged from the printed circuit heat exchanger 1 with a higher temperature by heat exchange with the first fluid. In addition, the printed circuit heat exchanger 1 may be a steam generator. Due to the steam generator, the second fluid may boil due to heat received from the first fluid in a second flow path member, which will be described later, and be then converted into steam. In addition, the printed circuit heat exchanger 1 may include a plurality of first flow path members 100 and a plurality of second flow path members 200.

The plurality of first flow path members 100 may provide a plurality of flow paths through which the first fluid may flow. In addition, the plurality of first flow path members 100 may be diffusion-bonded to the plurality of second flow path members 200. In addition, the plurality of first flow path members 100 and the plurality of second flow path members 200 may be diffusion-bonded and stacked in a preset order.

For example, the plurality of first flow path members 100 and the plurality of second flow path members 200 may be alternately stacked. In other words, one second flow path member 200 may be disposed between the plurality of first flow path members 100.

In another example, the plurality of first flow path members 100 and the plurality of second flow path members 100 may be stacked in a manner of repeatedly performing a process in which one of a first flow path member 100 and a second flow path member 200 is stacked several times and then the other one is stacked. In other words, after a plurality of first flow path members 100 is stacked, one second flow path member 200 may be stacked and another plurality of first flow path members 100 may be stacked again.

A bonded portion may be formed between a first flow path member 100 and a second flow path member 200 due to such diffusion bonding. The bonded portion may be formed along a surface of a plate, which will be described later, and may be an imaginary plane on which one or more air bubbles can be formed due to diffusion bonding. Hereinafter, a bonded portion formed between the first flow path member 100 and the second flow path member 200 is referred to as a first bonded portion S1, and a bonded portion formed between the plate and a bonding plate, which will be described later, is referred to as a second bonded portion S2.

In addition, the first flow path member 100 may include a first plate 110 and a first bonding plate 120.

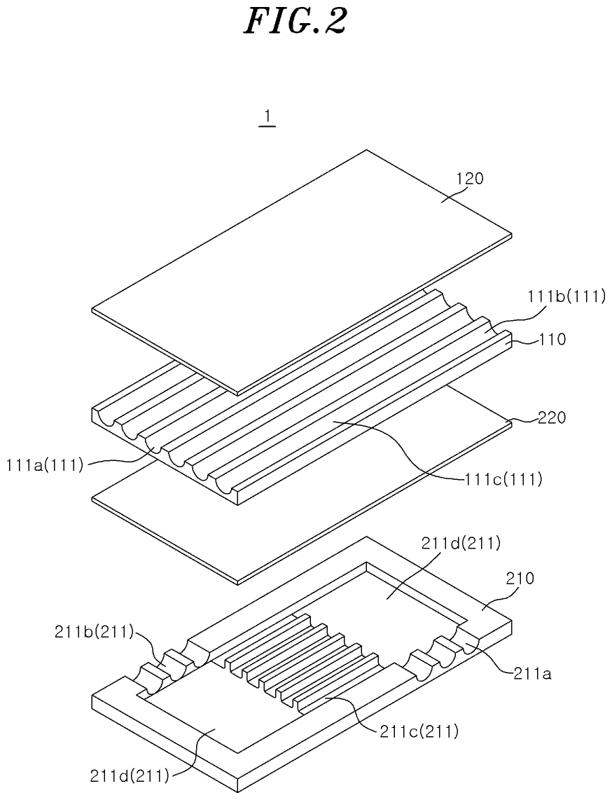

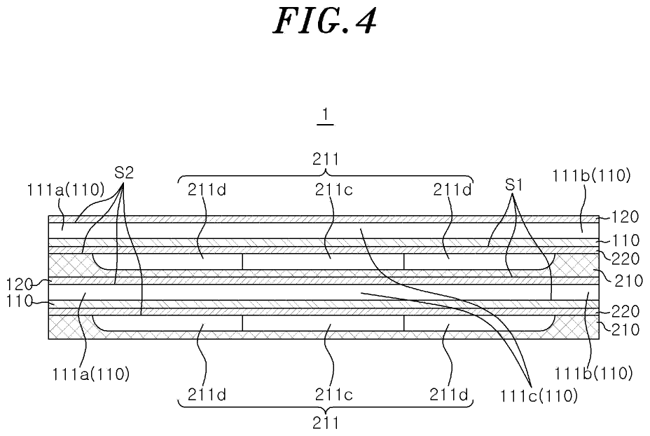

Referring further to FIGS. 2 to 4, the first plate 110 may include a first flow path portion 111 providing a plurality of flow paths through which the first fluid introduced into the printed circuit heat exchanger 1 flows. The first flow path portion 111 may be formed in one surface of the first plate 110 through chemical etching or machining, but the present disclosure is not limited thereto, and the first flow path portion 111 may be formed in both surfaces of the first plate 110. In addition, the first flow path portion 111 may include one or more first inflow paths 111a, one or more first discharge flow paths 111b, one or more first transfer flow paths 111c, and one or more first connection flow paths 111d.

The one or more first inflow paths 111a may include a plurality of first inflow paths 111a. The plurality of first inflow paths 111a are flow paths for introducing the first fluid. In other words, the first fluid may be introduced into the first flow path portion 111 through the plurality of first inflow paths 111a. The plurality of first inflow paths 111a each may be formed inwardly from one surface (an upper surface in FIG. 1) of the first plate 110 to have a shape opened toward the first bonding plate 120. Cross-sections of the plurality of first inflow paths 111a each may have a semicircle shape, a circular shape, or the like.

The one or more first discharge flow paths 111b may include a plurality of first discharge flow paths 111b. The plurality of first discharge flow paths 111b are flow paths for discharging the first fluid. In other words, the first fluid may be discharged from the first flow path portion 111 through the plurality of first discharge flow paths 111b. The plurality of first discharge flow paths 111b may be formed inwardly from one surface of the first plate 110 to have a shape opened toward the first bonding plate 120. Cross-sections of the plurality of first discharge flow paths 111b each may have a semicircular shape, a circular shape, or the like.

The one or more first transfer flow paths 111c may include a plurality of first transfer flow paths 111c. The plurality of first transfer flow paths 111c are flow paths through which the first fluid introduced from the plurality of first inflow paths 111a flows toward the plurality of first discharge flow paths 111b, so that the first fluid can exchange heat with the second fluid. In other words, the first fluid may flow to the plurality of first discharge flow paths 111b through the plurality of first transfer flow paths 111c. The plurality of first transfer flow paths 111c may be formed inwardly from one surface of the first plate 110 to have a shape opened toward the first bonding plate 120. The plurality of first transfer flow paths 111c may extend along an imaginary line connecting one side of the first plate and the other side opposite to the one side, but the present disclosure is not limited thereto. In addition, the cross-sections of the plurality of first transfer flow paths 111c each may have a shape such as a semicircle, a circle, or a rectangle in which at least one corner is rounded.

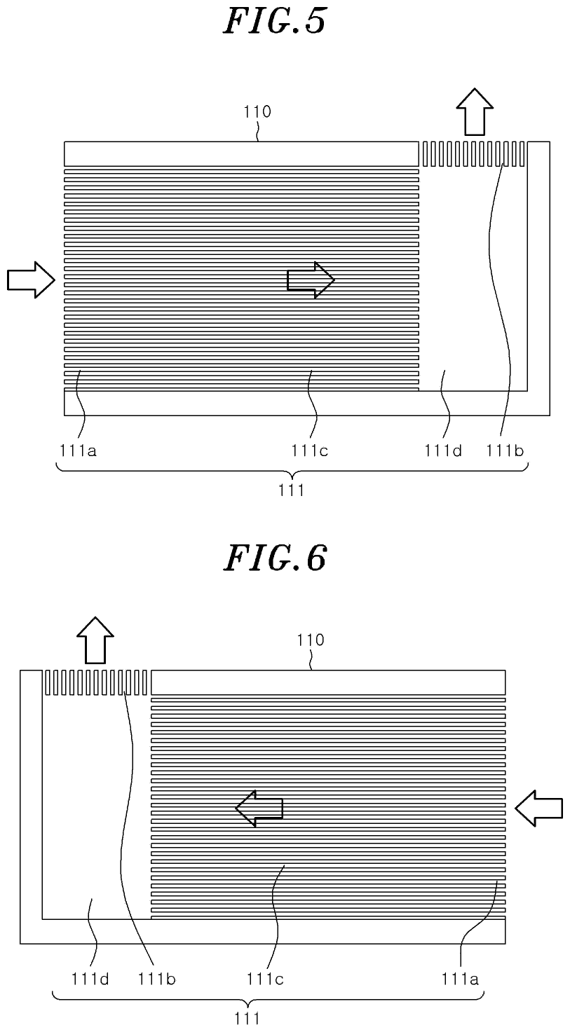

Referring to FIGS. 5 and 6, the one or more first connection flow paths 111d may include one first connection flow path 111d, and the first connection flow path 111d may be disposed between the plurality of first inflow paths 111a and the plurality of first discharge flow paths 111b so that the first fluid can flow. The first connection flow path 111d may communicate with the plurality of first transfer flow paths 111c and the plurality of first inflow paths 111a to transfer the first fluid flowing in the plurality of first inflow paths 111a to the plurality of first transfer flow paths 111c. In addition, the first connection flow path 111d may communicate with the plurality of first transfer flow paths 111c and the plurality of first discharge flow paths 111b to transfer the first fluid flowing in the plurality of first transfer flow paths 111c to the plurality of first discharge flow paths 111b. In other words, the first connection flow path 111d may be disposed between the plurality of first transfer flow paths 111c and the plurality of first inflow paths 111a or between the plurality of first transfer flow paths 111c and the plurality of first discharge flow paths 111b. The first fluid may flow into the plurality of first transfer flow paths 111c or the plurality of first discharge flow paths 111b through the first connection flow path 111d. The first connection flow path 111d may be formed inwardly from one surface of the first plate 110 to have a shape opened toward the first bonding plate 120.

In addition, the first connection flow path 111d may have a large first flow area to communicate with either the plurality of first inflow paths 111a or the plurality of first discharge flow paths 111b and with the plurality of first transfer flow paths 111c. The first flow area may have a shape in which a width is greater than a length perpendicular to the width, but the present disclosure is not limited thereto. The width of the first flow area refers to a length that is perpendicular to a direction in which the plurality of first transfer flow paths 111c extends and is parallel to the surface of the first plate 110.

Meanwhile, the plurality of first inflow paths 111a, the plurality of first discharge flow paths 111b, the plurality of first transfer flow paths 111c, and the plurality of first connection flow paths 111d may be connected in various ways as follows.

For example, as shown in FIG. 2, the plurality of first inflow paths 111a may be formed in one side of the first plate 110 and the plurality of first discharge flow paths 111b may be formed on the other side of the first plate 110, so that the first fluid flows from one side of the first plate 110 to the other side opposite to the one side. In this case, at least one of the plurality of first transfer flow paths 111c and the first connection flow path 111d may be disposed between the plurality of first inflow paths 111a and the plurality of first discharge flow paths 111b.

In another example, as shown in FIGS. 5 and 6, the plurality of first inflow flow paths 111a and the plurality of first discharge flow path 111b may be formed in several sides of the first plate 110, so that a direction from which the first fluid is introduced is different from a direction in which the first fluid is discharged. In this case, the first connection flow path 111d may be disposed between the plurality of first discharge flow paths 111b and the plurality of first transfer flow paths 111c, or may be disposed between the plurality of first inflow paths 111a and the plurality of first transfer flow paths 111c. Further, the first connection flow path 111d may be disposed between the plurality of first discharge flow paths 111b and the plurality of first transfer flow paths 111c and between the plurality of first inflow paths 111a and the plurality of first transfer flow paths 111c.

Meanwhile, a width of each first inflow path 111a, a width of each first discharge flow path 111b, and a width of each first transfer flow path 111c may be the same, but the present disclosure is not limited thereto. Here, a width may be a length that is perpendicular to a direction in which each flow path extends and is parallel to the surface of the first plate 110.

The first bonding plate 120 may be diffusion-bonded to one surface of the first plate 110 to cover the first flow path portion 111. A second bonded portion S2 may be formed between the first bonding plate 120 and the first plate 110.

The first plate 110 and the first bonding plate 120 may be diffusion-bonded under vacuum or a low-oxygen condition in order to minimize oxidation that could occur during a diffusion bonding process. In addition, in order to remove an oxide layer that is formed during the diffusion bonding, the surface of the first flow path member 100 may be deoxidized using atmospheric plasma or cathodic polarization. In addition, the surface of the first flow path member 100 may be machined to remove the oxide layer.

The plurality of second flow path members 200 may provide a flow path through which the second fluid introduced into the printed circuit heat exchanger 1 may flow. The second fluid may flow in the second flow path member 200 so that the second fluid can exchange heat with the first fluid flowing in the first flow path member 100. In addition, the surface of the second flow path member 200 may be deoxidized or processed to remove the oxide layer that is formed during diffusion bonding of the second plate 210 and the second bonding plate 220. The plurality of second flow path members 200 may include the second plate 210 and the second bonding plate 220.

In the second plate 210, a second flow path portion 211 providing a plurality of flow paths through which the second fluid introduced into the printed circuit heat exchanger 1 flows may be formed. The second flow path portion 211 may be processed at one surface of the second plate 210 (an upper surface of the second plate 210 in FIG. 2) through chemical etching or machining, but the present disclosure is not limited thereto, and the second flow path portion 211 may be processed at both sides of the second plate 210. The second flow path portion 211 may include a plurality of second inflow paths 211a, a plurality of second discharge flow paths 211b, a plurality of second transfer flow paths 211c, and a plurality of second connection flow paths 211d.

The plurality of second inflow paths 211a is flow paths for introducing the second fluid. In other words, the second fluid may be introduced into the second flow path portion 211 through the plurality of second inflow paths 211a. The plurality of second inflow paths 211a may be formed inwardly from one surface of the second plate 210 to have a shape opened toward the second bonding plate 220. Cross-sections of the plurality of second inflow paths 211a each may have a semicircle shape, a circular shape, or the like.

The plurality of second discharge flow paths 211b is flow paths for discharging the second fluid. In other words, the second fluid may be discharged from the second flow path portion 211 through the plurality of second discharge flow paths 211b. The plurality of second discharge flow paths 211b may be formed inwardly from one surface of the second plate 210 to have a shape opened toward the second bonding plate 220. Cross-sections of the plurality of second discharge flow paths 211b each may have a semicircle shape, a circular shape, or the like.

The plurality of second transfer flow paths 211c is flow paths through which the second fluid introduced through the plurality of second inflow paths 211a flows toward the plurality of second discharge flow paths 211b so that the second fluid can exchange heat with the first fluid. In addition, the plurality of second transfer flow paths 211c may be formed between the plurality of second inflow paths 211a and the plurality of second discharge flow paths 211b. In other words, the second fluid may flow to the plurality of second discharge flow paths 211b through the plurality of second transfer flow paths 211c. The plurality of second transfer flow paths 211c may be formed inwardly from one surface of the second plate 210 to have a shape opened toward the second bonding plate 220. A flow direction of the second fluid in the plurality of second transfer flow paths 211c and a flow direction of the first fluid in the plurality of first transfer flow paths 111c may be opposite to each other. The plurality of second transfer flow paths 211c may extend along an imaginary line connecting one side of the second plate 210 and the other side opposite to the one side, but the present disclosure is not limited thereto. In addition, cross-sections of the plurality of second transfer flow paths 211c each may have a shape such as a semicircle, a rectangle with at least one rounded corner, a circle, or the like.

One of the second connection flow paths 211d may communicate with the plurality of second transfer flow paths 211c and the plurality of second inflow paths 211a to transfer the second fluid flowing in the plurality of second inflow paths 211a to the plurality of second transfer flow paths 211c. In addition, another of the second connection flow paths 211d may communicate with the plurality of second transfer flow paths 211c and the plurality of second discharge flow paths 211b to transfer the second fluid flowing in the plurality of second transfer flow paths 211c to the plurality of second discharge flow paths 211b. In other words, the second connection flow paths 211d may be disposed at least one of a portion between the plurality of second transfer flow paths 211c and the plurality of second inflow paths 211a and a portion between the plurality of second transfer flow paths 211c and the plurality of second discharge flow paths 211b. The second fluid may flow into the plurality of second transfer flow paths 211c or the plurality of second discharge flow paths 211b through the second connection flow paths 211d. The second connection flow paths 211d may be formed inwardly from one surface of the second plate 210 to have a shape opened toward the second bonding plate 220.

In addition, each of the second connection flow paths 211d may has a large second flow area to communicate with one of the plurality of the second inflow paths 211a and the plurality of second discharge flow paths 211b and with the second transfer flow path 211c. The second flow area may have a shape in which a width is larger than a length perpendicular to the width, but the present disclosure is not limited thereto. The width of each of the second connection flow paths 211d may refer to a length that is perpendicular to a direction in which the plurality of second transfer flow paths 211c extends and is parallel to the surface of the second plate 210.

Meanwhile, the plurality of second inflow paths 211a, the plurality of second discharge flow paths 211b, the plurality of second transfer flow paths 211c, and the plurality of second connection flow paths 211d may be connected in various ways as follows.

For example, as shown in FIG. 2, the plurality of second inflow paths 211a and the plurality of second discharge flow paths 211b may be formed at several portions of the second plate 210 so that a direction from which the second fluid is introduced and a direction in which the second fluid is discharged are parallel to each other. In this case, the second connection flow path 211d may be disposed a portion between the plurality of second discharge flow paths 211b and the plurality of second transfer flow paths 211c and a portion between the plurality of second inflow paths 211a and the plurality of second transfer flow path 211c.

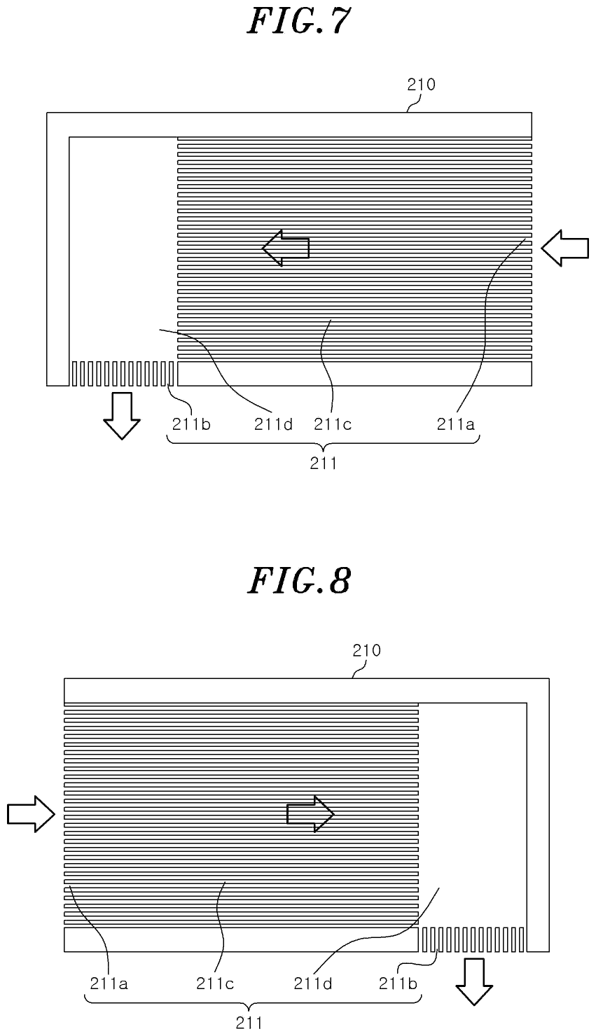

In FIG. 2, each of the second inflow paths 211a, the second discharge flow paths 211b, and the second connection flow paths 211d is provided in plural. However, the present disclosure is not limited thereto, and one second inflow path 211a, one second discharge flow path 211b, and/or one second connection flow path 211d may be provided. In another example, as shown in FIGS. 7 and 8, the plurality of second inflow paths 211a and the plurality of second discharge paths 211b may be formed at several sides of the second plate 210 so that a direction from which the second fluid is introduced is different from a direction in which the second fluid is discharged. In this case, the second connection flow path 211d may be disposed between the plurality of second discharge flow paths 211b and the plurality of second transfer flow paths 211c or may be disposed between the plurality of second inflow paths 211a and the plurality of second transfer flow paths 211c.

The second bonding plate 220 may be diffusion-bonded to one surface of the second plate 210 to cover the second flow path portion 211. A second bonded portion S2 may be formed between the second bonding plate 220 and the second plate 210.

The second plate 210 and the second bonding plate 220 may be diffusion-bonded under vacuum or a low-oxygen condition in order to minimize oxidation that could occur during a diffusion bonding process. In addition, in order to remove an oxide layer that is formed during the diffusion bonding, the surface of the second flow path member 200 may be deoxidized using atmospheric plasma or cathodic polarization. In addition, the surface of the second flow path member 200 may be machined to remove the oxide layer.

In addition, when a plurality of first flow path members 100 and a plurality of second flow path members 200 are bonded, the second bonding plate 220 and the first plate 110 may be diffusion-bonded to each other, the second plate 210 and the first bonding plate 120 may be diffusion-bonded to each other, the first bonding plate 120 and the second bonding plate 220 may be diffusion-bonded to each other, or the first plate 110 and the second plate 210 may be diffusion-bonded to each other.

Hereinafter, step and effects of the printed circuit heat exchanger 1 according to the first embodiment of the present disclosure will be described.

In the printed circuit heat exchanger 1 according to the first embodiment of the present disclosure, since the first connection flow path 111d having a large first flow area and the second connection flow path 211d having a large second flow area can be formed, heat exchange efficiency may increase in accordance with an increase in a heat transfer area.

In addition, since a flow velocity of the fluid flowing in the first connection flow path 111d or the second connection flow path 211d having a large flow area can be reduced and flow resistance at a wall surface of a flow path can be reduced, a pressure loss may be reduced. In addition, flow resistance of the first connection flow path 111d or the second connection flow path 211d may be smaller than flow resistance of other flow paths. In other words, in the first connection flow path 111d, a flow rate of the first fluid flowing at a portion adjacent to the plurality of first inflow paths 111a and a flow rate of the first fluid flowing at a portion spaced apart from the plurality of first inflow paths 111a may be similar to each other. In addition, in the second connection flow path 211d, a flow rate of the second fluid flowing at a portion adjacent to the plurality of second inflow paths 211a and a flow rate of the second fluid flowing at a portion spaced apart from the plurality of second inflow paths 211a may be similar to each other. The uniform flow distribution in the first connection flow path 111d or the second connection flow path 211d may advantageously affect the heat transfer performance of the printed circuit heat exchanger 1.

Hereinafter, a method of manufacturing the printed circuit heat exchanger 1 according to the first embodiment of the present disclosure will be described.

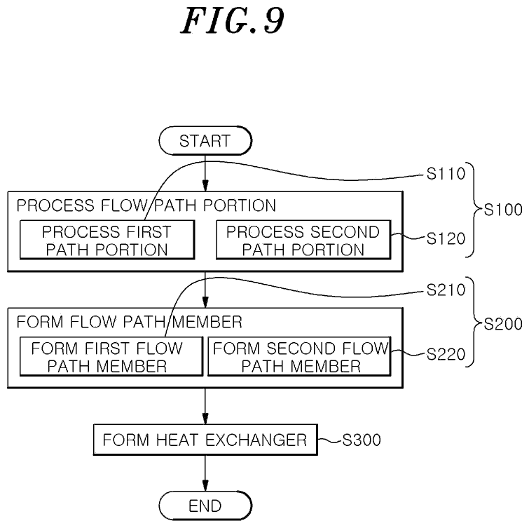

Referring to FIG. 9, the method of manufacturing a printed circuit heat exchanger according to the first embodiment of the present disclosure may include a flow path portion processing step S100, a flow path member forming step S200, and a heat exchanger forming step S300.

The flow path portion processing step S100 is a step of forming, in the plurality of plates 110 and 210, the flow path portions 111 and 211 through which a fluid can flow. The flow path portion processing step S100 may include a first flow path portion processing step S110 and a second flow path portion forming step S120.

The first flow path portion processing step S110 is a step of forming, in the first plate 110, the first flow path portion 111 providing a plurality of flow paths through which the first fluid flows. The first flow path portion 111 may be formed through chemical etching or machining. In the first flow path portion processing step S110, at least one of the plurality of first inflow paths 111a, the plurality of first discharge flow paths 111b, the plurality of first transfer flow paths 111c, and the plurality of first connection flow path 111d may be formed in the first plate 110. In addition, the first connection flow path 111d may have a large first flow area to communicate with the plurality of first inflow paths 111a and the plurality of first transfer flow paths 111c or to communicate with the plurality of first discharge flow paths 111b and the plurality of first transfer flow paths 111c. The first flow path portion processing step S110 and the second flow path portion processing step S120 may be performed simultaneously, or one of the first flow path portion processing step S110 and the second flow path portion processing step S120 may be performed first.

The second flow path portion processing step S120 is a step of forming, in the second plate 210, the second flow path portion 211 providing a plurality of flow paths through which the second fluid flows. The second flow path portion 211 may be formed through chemical etching or machining. In the second flow path portion processing step S120, the plurality of second inflow paths 211a, the plurality of second discharge flow paths 211b, the plurality of second transfer flow paths 211c, and at least one of second connection flow paths 211d may be formed in the second plate 210. In addition, the second connection flow path 211d may have a large second flow area to communicate with the plurality of second inflow paths 211a and the plurality of second transfer flow paths 211c or to communicate with the plurality of second discharge flow paths 211b and the plurality of second transfer flow paths 211c.

The flow path member forming step S200 is a step of forming the plurality of flow path members 100 and 200 by diffusion bonding of at least one of the plurality of plates 110 and 210 and the bonding plates 120 and 220. In addition, in the flow path member forming step S200, at least one of the plurality of plates 110 and 210 and the bonding plates 120 and 220 may be diffusion-bonded under vacuum or in a state where inert gas is filled instead of air in order to minimize oxidation that could occur during the diffusion bonding process. For example, for the diffusion bonding process, the inside of a furnace in which the first plate 110 and the first bonding plate 120 are accommodated may be formed in a vacuum state, or argon may be slowly injected into the furnace. In addition, in the flow path member forming step S200, when an oxide layer is formed during the diffusion bonding process, the surfaces of the plurality of flow path members 100 and 200 may be deoxidized or processed to remove the oxide layer. For example, the deoxidation treatment may be performed through atmospheric pressure plasma, cathodic polarization, or the like.

The flow path member forming step S200 may include a first flow path member forming step S210 and a second flow path member forming step S220.

The first flow path member forming step S210 is a step of forming the flow path member 100 by diffusion-bonding the first bonding plate 120 to the first plate 110 so that the first flow path portion 111 of the first plate 110 is covered. In the first flow path member forming step S210, a second bonded portion S2 may be formed between the first plate 110 and the first bonding plate 120 by diffusion bonding. In addition, in the first flow path member forming step S210, a surface of the first flow path member 100 may be deoxidized or processed to remove an oxide layer that is formed when the first plate 110 and the first bonding plate 120 are diffusion-bonded.

The second flow path member forming step S220 is a step of forming the second flow path member 200 by diffusion-bonding the second bonding plate 220 to the second plate 210 so that the second flow path portion 211 of the second plate 210 is covered. In the second flow path member forming step S220, a second bonded portion S2 may be formed between the second plate 210 and the second bonding plate 220 by diffusion bonding. In addition, in the second flow path member forming step S220, a surface of the second flow path member 200 may be deoxidized or processed to remove an oxide layer that is formed when the second plate 210 and the second bonding plate 220 are diffusion-bonded.

The first flow path member forming step S210 and the second flow path member forming step S220 may be simultaneously performed, or one of the first flow path member forming step S210 and the second flow path member forming step S220 may be performed first.

The heat exchanger forming step S300 is a step of forming a printed circuit heat exchanger 1 by diffusion-bonding a plurality of flow path members. In addition, in the heat exchanger forming step S300, the plurality of first flow path members 100 and the plurality of second flow path members 200 may be diffusion-bonded and stacked in a preset order, as described above.

For example, the plurality of first flow path members 100 and the plurality of second flow path members 200 may be alternately stacked. In other words, one second flow path member 200 may be disposed between the plurality of first flow path members 100.

In another example, the plurality of first flow path members 100 and the plurality of second flow path members 100 may be stacked in a manner of repeatedly performing a process in which one of the first flow path members 100 and the second flow path members 200 is stacked several times and then the other one is stacked. In other words, after a plurality of first flow path members 100 is stacked, one second flow path member 200 may be stacked and another plurality of first flow path members 100 may be stacked again.

In addition, in order to bond the first flow path member 100 and the second flow path member 200, the first plate 110 and the second bonding plate 220 may be diffusion-bonded to each other, the second plate 210 and the first bonding plate 120 may be diffusion-bonded to each other, the first bonding plate 120 and the second bonding plate 220 may be diffusion-bonded to each other, or the first plate 110 and the second plate 210 may be diffusion-bonded to each other.

Hereinafter, operation and effects of the method of manufacturing the printed circuit heat exchanger 1 according to the first embodiment of the present disclosure will be described.

In the flow path member forming step S200 in the method of manufacturing the printed circuit heat exchanger 1 according to the first embodiment of the present disclosure, a plate and a bonding plate may be primarily diffusion-bonded, and in the heat exchanger forming step S300, a plurality of flow path members may be secondarily diffusion-bonded. Due to such diffusion bonding, pressure may be adequately transferred to the entire area of the second bonded portion S2, which is a diffusion-bonded portion constituting the first flow path portion 111 and the second flow path portion 211, so that the diffusion bonding is sufficiently performed. In addition, as the diffusion bonding is performed sufficiently, structural integrity may be secured, and thus, a fluid leakage from the first flow path portion 111 and the second flow path portion 211 may be prevented.

Hereinafter, a printed circuit heat exchanger 1 according to a second embodiment of the present disclosure will be described. In describing the second embodiment, the difference from the above-described embodiments lies in that an opening may be formed in at least one of the first flow path portion 111 and the second flow path portion 211, and the following mainly explained with such a difference and the same description and reference numerals as described above will be omitted.

First, formation of an opening in the second flow path portion 211 will be described.

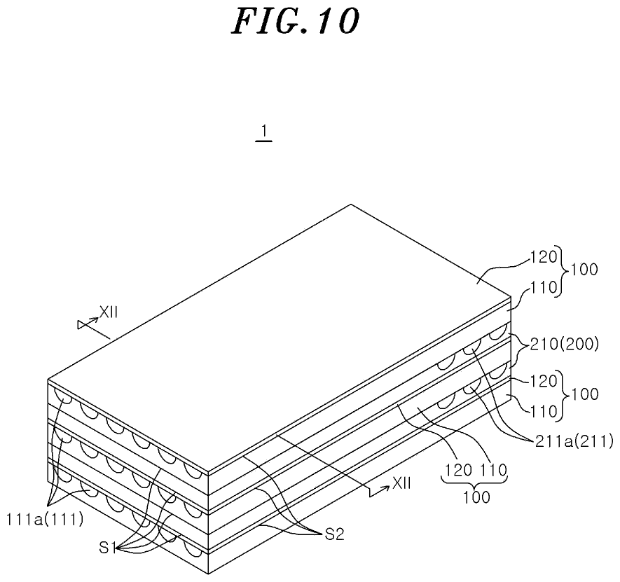

Referring to FIGS. 10 to 12, the second plate 210 may be diffusion-bonded to the first flow path member 100.

For example, one surface of the second plate 210 and the other surface opposite to the one surface may be diffusion-bonded to first flow path members 100, respectively. In other words, one surface of the second plate 210 may be diffusion-bonded to the first plate 110 or the first bonding plate 120 of any one of a plurality of first flow path members 100 or to the first bonding plate 120, and the other surface of the second plate 210 may diffusion-bonded to the first bonding plate 120 or the first plate 110 of another one of the plurality of first flow path members 100.

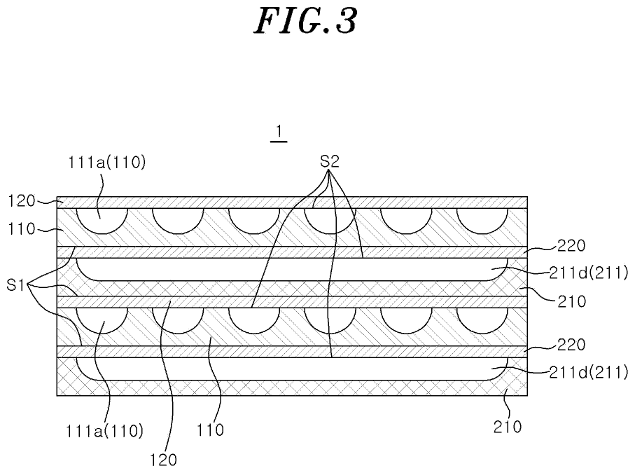

In another example, when the second plate 210 is laminated on the first flow path member 100 to be disposed on an outside (the top or bottom in FIG. 3) of the printed circuit heat exchanger 1, the second bonding plate 220 may be diffusion-bonded. In other words, one surface of the second plate 210 may be diffusion-bonded to the first plate 110 or the first bonding plate 120 of the first flow path member 100, and the other surface of the second plate 210 may be diffusion-bonded to the second bonding plate 220.

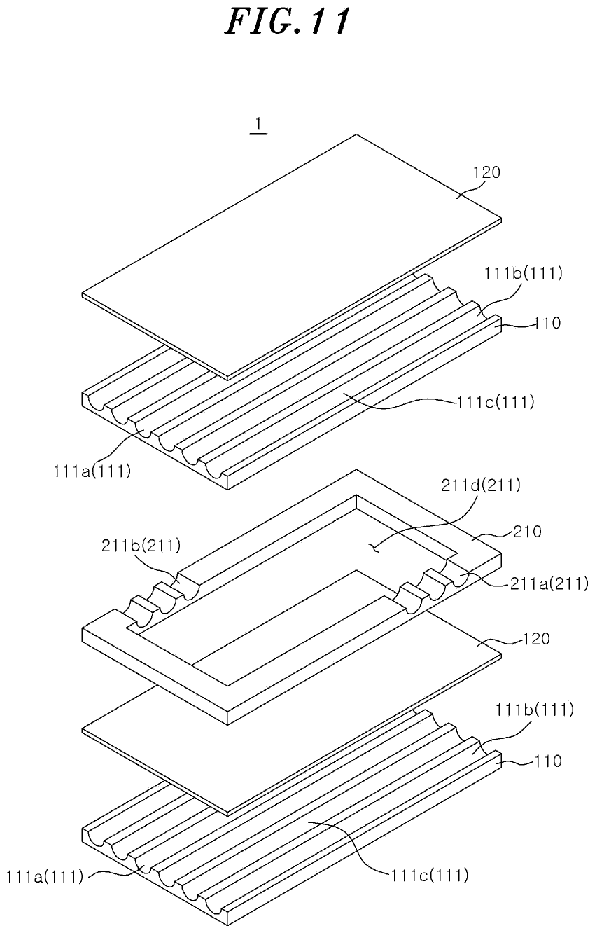

A second connection flow path 211d may be an opening communicating with the second inflow paths 211a and the second discharge flow paths 211b. In other words, a second fluid may be introduced into the second inflow paths 211a and may be discharged by flowing into the second discharge flow paths 211b through the opening. Such an opening may be formed in a central portion of the second plate 210. In addition, the opening may be processed in the second plate 210 through chemical etching or machining. In addition, although the opening is illustrated as having a rectangular shape in FIG. 11, the shape of the opening is not limited to the rectangular shape and may also include a fillet or a corner. The opening may be covered by a plurality of first flow path members 100 or may be covered by a first flow path member 100 and a second bonding plate 220. The second fluid flowing through the opening may flow toward the plurality of second discharge flow paths 211b from a portion between the plurality of first flow path members 100 or a portion between the first passage member 100 and the second bonding plate 220.

Hereinafter, formation of an opening in the first flow path portion 111 will be described. An opening formed in the first flow path portion 111 is referred to as a first opening, and an opening formed in the second flow path portion 211 is referred to a second opening.

The first plate 110 may be diffusion-bonded to the second flow path member 200.

For example, one surface of the first plate 110 and the other surface opposite to the one surface may be diffusion-bonded to second flow path members 200, respectively. In other words, one surface of the first plate 110 may be diffusion-bonded to the second plate 210 or the second bonding plate 220 of any one of the second flow path members 200, and the other surface of the first plate 110 may be diffusion-bonded to the second bonding plate 220 or the second plate 210 of another one of the second flow path members 200.

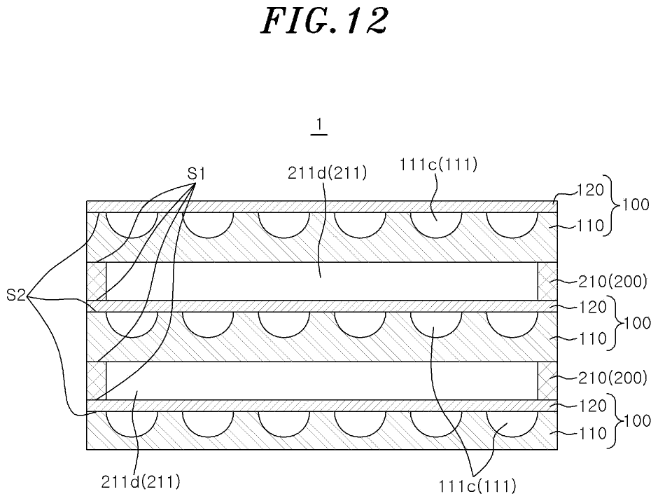

In another example, when the first plate 110 is laminated on the second flow path member 200 to be disposed on an outside of the printed circuit heat exchanger 1 (the top or bottom of the printed circuit heat exchanger 1 when disposed as shown in FIG. 12), the first bonding plate 120 may be diffusion-bonded. In other words, one surface of the first plate 110 may be diffusion-bonded to the second plate 210 or the second bonding plate 220 of the second flow path member 200, and the other surface of the first plate 110 may be diffusion-bonded to the first bonding plate 120.

The first connection flow path 111d may be formed as a first opening to communicate with the first inflow path 11a and the first discharge flow path 111b. In other words, the first fluid may be introduced into the first inflow paths 111a and may be discharged by flowing into the first discharge flow paths 111b through the first opening. The first opening may be formed in a central portion of the first plate 110. In addition, the first opening may be processed in the first plate 110 through chemical etching or machining. Further, the first opening may be formed in a rectangular shape or may include a fillet or a corner. The first opening may be covered by the second flow path members 200 or may be covered by the second flow path member 200 and the first bonding plate 120. A first fluid flowing through the first opening may flow toward the first discharge flow paths 111b from a portion between the second flow path members 200 or a portion between the second flow path member 200 and the first bonding plate 120.

Hereinafter, it will be described that the first opening is formed in the first flow path portion 111 and the second opening is formed in the second flow path portion 211.

The first flow path member 100 and the second flow path member 200 may be diffusion-bonded through the first bonding plate 120 or the second bonding plate 220. In other words, the first bonding plate 120 or the second bonding plate 220 may be disposed between the first plate 110 and the second plate 210.

In addition, a separate bonding plate may be further diffusion-bonded to any one of the first plate 110 and the second plate 120 that is disposed at an edge of the printed circuit heat exchanger 1.

The first opening may be covered by the first bonding plate 120 and the second bonding plate 220 due to the first plate 110 and the second plate 210 or may be covered by the first bonding plate 120 and a separate bonding plate. In addition, the second opening may be covered by the first bonding plate 120 and the second bonding plate 220 or may be covered by the second bonding plate 220 and a separate bonding plate.

Hereinafter, operation and effects of the printed circuit heat exchanger 1 according to the second embodiment of the present disclosure will be described.

Due to a large opening in the printed circuit heat exchanger 1 according to the second embodiment, a flow path cross-sectional area may increase and a flow velocity of a fluid may be reduced, and thus, flow resistance of the flow path portions 111 and 211 may be lowered.

Hereinafter, a method of manufacturing the printed circuit heat exchanger 1 according to the second embodiment of the present disclosure will be described. In describing the second embodiment, the difference from the above-described embodiments lies in that an opening may be formed in at least one of the first flow path portion 111 and the second flow path portion 211 during the flow path portion processing step S100, and the following mainly explained with such a difference and the same description and reference numerals as described above will be omitted.

In the first flow path portion processing step S110, the first opening may be formed in the first plate 110 to form the first connection flow path 111d. The first opening may communicate with the plurality of first inflow paths 111a and the plurality of first discharge flow paths 111b.

In the second flow path portion processing step S120, the second opening may be formed in the second plate 210 to form the second connection flow path 211d. The second opening may communicate with the plurality of second inflow paths 211a and the plurality of second discharge flow paths 211b.

In the heat exchanger forming step S300, the second plate 210 and the first flow path member 100 may be diffusion-bonded to each other, for example, as described above. In another example, the first plate 110 may be diffusion-bonded to the second flow path member 200. In still another example, the first flow path member 100 and the second flow path member 200 may be diffusion-bonded through the first bonding plate 120 or the second bonding plate 220.

Hereinafter, operation and effects of the method of manufacturing the printed circuit heat exchanger 1 according to the second embodiment of the present disclosure will be described.

Due to the opening in the printed circuit heat exchanger 1 according to the second embodiment, it is possible to diffusion bond the second plate 210 and the first flow path member 100 or the first plate 110 and the second flow path member 200 without the second bonding plate, thereby reducing manufacturing time and cost.

In addition, since heat exchange between the first fluid and the second fluid can be performed through the first plate or the second plate instead of a diffusion-bonded plate, a possibility of degradation of heat transfer due to a diffusion bonding defect may be suppressed compared to the first embodiment.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. A heat exchanger comprising:
a first flow path member including a first plate having a first flow path portion providing a plurality of flow paths through which a first fluid flows, and a first bonding plate diffusion-bonded to the first plate to cover the first flow path portion; and
a second flow path member including a second plate having a second flow path portion providing a plurality of flow paths through which a second fluid for exchanging heat with the first fluid flows,
wherein the first flow path member and the second flow path member are diffusion-bonded to each other.

2. The heat exchanger of claim 1, wherein the second flow path member further comprises a second bonding plate diffusion-bonded to the second plate to cover the second flow path portion.

3. The heat exchanger of claim 1, wherein the first flow path member includes a plurality of first flow path members,
wherein the second flow path member is disposed between the plurality of first flow path members, and
wherein an opening is formed in the second flow path portion so that the second fluid flows between the plurality of first flow path members.

4. The heat exchanger of claim 2, wherein a surface of the first flow path member and a surface of the second flow path member are deoxidized or processed to remove an oxide layer that is formed when the first plate and the first bonding plate are diffusion-bonded or when the second plate and the second bonding plate are diffusion-bonded.

5. A method of manufacturing a heat exchanger, comprising:
a flow path portion processing step in which a flow path portion through which a fluid flows is formed in a plurality of plates;
a flow path member forming step in which at least one of the plurality of plates and a bonding plate are diffusion-bonded to form a plurality of flow path members; and
a heat exchanger forming step in which the plurality of flow path members are diffusion-bonded.

6. The method of claim 5, wherein the plurality of plates comprises a first plate and a second plate,
wherein the flow path portion processing step comprises:
a first flow path portion processing step in which a first flow path portion providing a plurality of flow paths through which a first fluid flows is formed in the first plate; and
a second flow path portion processing step in which a second flow path portion providing a plurality of flow paths through which a second fluid flows is formed in the second plate,
wherein the flow path member forming step comprises:
a first flow path member forming step in which a first flow path member is formed by diffusion-bonding a first bonding plate to the first plate so that the first flow path portion of the first plate is covered; and
a second flow path member forming step in which a second flow path member is formed by diffusion bonding a second bonding plate to the second plate so that the second flow path portion of the second plate is covered.

7. The method of claim 6, wherein in the first flow path member forming step, a surface of the first flow path member is deoxidized or processed to remove an oxide layer that is formed when the first plate and the first bonding plate are diffusion-bonded, and
wherein, in the second flow path member forming step, a surface of the second flow path member is deoxidized or processed to remove an oxide layer that is formed when the second plate and the second bonding plate are diffusion-bonded.

8. The method of claim 7, wherein, in the heat exchanger forming step, the second bonding plate and the first plate are diffusion-bonded to each other, the first bonding plate and the second plate are diffusion-bonded to each other, the first plate and the second plate are diffusion-bonded to each other, or the first bonding plate and the second bonding plate are diffusion-bonded to each other.

9. The method of claim 5, wherein, in the flow path portion processing step, an opening is formed in at least one flow path portion of the plurality of plates.

10. The method of claim 5, wherein, in the flow path member forming step, at least one of the plurality of plates and the bonding plate are diffusion-bonded in a vacuum or in an inert gas atmosphere.
